(19) United States
(12) Patent Application Publication
(10) Pub. No.: US 2010/0193591 A1
(43) Pub. Date: Aug. 5, 2010

(54) METHOD OF FABRICATING AN INSERT INCLUDING AN RFID DEVICE

(75) Inventors: Sandrine Rancien, La Murette (FR); Pascal Marlin, Coulommiers (FR)

Correspondence Address: Oliff & Berridge, PLC, P.O. Box 320850, Alexandria, VA, 22320-4850, US

(73) Assignee: ARJOWIGGINS SECURITY, PARIS (FR)

(21) Appl. No.: 12/671,089

(22) PCT Filed: Aug. 1, 2008
(86) PCT No.: PCT/FR2008/051455

§ 371 Date: Apr. 5, 2010

(30) Foreign Application Priority Data
Aug. 3, 2007 (FR) 0756931

(51) Int. Cl. G06K 19/067; G06K 19/02; B29C 65/50; B32B 38/00; B29C 65/08; B29C 65/14

(52) U.S. Cl. 235/488; 156/60; 156/275.7; 156/73.1; 156/325

(57) ABSTRACT

The present invention relates to a method of fabricating an insert comprising at least a first flexible support, a second flexible support assembled with the first, and an RFID device that is situated at least in part between the two supports, the method comprising the steps consisting in depositing at least one adhesive on a face of at least one of the supports, the other support carrying at least one active substance, and assembling the two supports together, the active substance being capable of causing or accelerating a reaction process with the adhesive.

The present invention relates to an insert with a radiofrequency identity device (RFID) that comprises a wire antenna and an insulated circuit chip, the insert being for incorporating in a security document such as a passport or an identity card (ID), for example.

The invention also relates to the method of fabricating such an insert.

An insert as used in a security document comprises at least two flexible supports of fiber or non-fiber base, the antenna of the RFID device extending on one of the supports, and each support optionally including a recess for receiving the chip, in full or in part.

The two supports and the RFID device need to be assembled together in irreversible manner with the help of one or more adhesives so that the antenna is sandwiched between the two supports and optionally so that the chip is housed in the recesses of the two superposed supports.

An assembly is said to be “irreversible” when it is made tamperproof by virtue of its physical and mechanical strength and also its chemical inertness, the assembly being capable of preventing any fraudulent removal of the RFID device for the purpose of being reused in some other document.

Any attempt at falsifying an insert by peeling while dry, at high temperature, in water, or in other solvents, must be impossible, or must lead to the insert being destroyed, and in particular to the RFID device being destroyed.

Patent application US 2006/0005050 describes an insert for incorporating in a passport, the insert presenting specific physical characteristics for revealing any attempt at falsification, in particular by peeling. Such evidence of falsification is provided by the presence of zones of weakness on the chip and by using an adhesive with voids for fastening the antenna. The insert is based on a plastics material such as Teslin® or Artysin®. The insert described is made from a single support and offers no protection to the antenna which is flush with the surface of the support and is not sandwiched between two supports.

Publication WO 2006/079904 discloses an insert for an ID document that comprises a twin-layer structure having two layers of paper that are coated on their inside faces with a plastics material, the RFID device being sandwiched between the two layers of plastics material by them being assembled together while hot. The plastics material coated on the inside faces of the two pieces of paper is a thermoplastic material such as polyethylene. Such an insert presents the drawback of not being proof against tampering, in particular by peeling while hot. After the two thermoplastic layers have been assembled together while hot, they can be softened or melted once more, thereby enabling the device to be removed.

Patent application WO 2006/000849 describes an insert comprising a multilayer structure with at least two flexible layers and an internal flexible support of limited size, having positioned thereon both a module and an antenna. The support and the RFID device are compensated in thickness by various intermediate layers. In order to make the insert tamperproof and in particular in order to avoid it being possible to remove the RFID device by peeling apart the layers constituting the insert, it is proposed to make holes in register with each of the layers making up the insert, with the exception of the flexible outer layers, and to fill them with an adhesive that provides simultaneously chemical resistance and mechanical strength, such as an epoxy, a polyimide, or an ultraviolet (UV)-activatable adhesive. That publication also makes provision for using rivets made of plastics material or of metal instead of adhesive. The outer layers may be constituted by a material that is fiber-based or plastics-based. Such an insert withstands attempts at falsification but is relatively complicated to make, because of the relatively large number of layers involved and because of the number of operations that need to be performed.

The invention thus seeks to propose an insert for a security document that can withstand falsification and that is relatively simple to make.

In a first of its aspects, the invention provides a method of fabricating an insert comprising at least a first flexible support, a second flexible support assembled with the first, and an RFID device that is situated at least in part between the two supports, the method comprising the steps consisting in:
depositing at least one adhesive on a face of at least one of the supports, the other support carrying at least one active substance; and
assembling the two supports together, the active substance being capable of causing or accelerating a reaction process with the adhesive.

The term “carrying” should be understood as covering both contained in the bulk of the support and/or present on its surface, either on its own, or else in an adhesive or any other coating on the support, such as a varnish, for example.

The active substance may be a catalyst capable of triggering and/or accelerating a chemical reaction with one of the components of the adjacent adhesive, while itself remaining unchanged at the end of the reaction.

The active substance may be a polymerization activator or initiator that is capable of triggering or enhancing the polymerization of one or more components of the adjacent adhesive, where polymerization consists in transforming a component into another component of multiple molecular weight.

The active substance may also be a hardener or a cross-linking agent capable of triggering or encouraging cross-linking of one or more components of the adjacent adhesive, in order to obtain three-dimensional structures by establishing bridges between molecular chains.

The active substance may be capable of causing or accelerating the reaction process as soon as it is put into contact with the adhesive. In other words, during the operation of assembling the supports together, the active substance may act spontaneously as soon as it comes into contact with one of the components of the adjacent adhesive.

The active substance may also require help from an external stimulus in order to trigger or accelerate the reaction process, which stimulus may be a rise in temperature, or exposure to UV radiation, for example. Thus, the active substance may respond on being put into contact with one of the components of the adjacent adhesive under the action of an external stimulus such as humidity, heat, UV or other radiation, e.g. radiation from an electron beam (EB). The action of the active substance may be enhanced, where appropriate, by applying pressure, e.g. by rolling the supports or by placing them in a press.

Immediately before assembling the two supports together, the active substance present in at least one of the two supports or in the adhesive can also be released by applying heat, prior to the two supports being placed one against the other.

The active substance may be incorporated in one of the flexible supports during fabrication thereof, by being incorporated in the mass thereof or by applying a surface treatment, by spraying, by a pasting press, by impregnation, by direct coating, or by transfer, e.g. using photogravure, offset printing, reverse roll printing, a slot system, a trailing blade system, an air blade system, a threaded bar system, this list not being limiting.

The active substance may also be applied to one of the flexible supports by surface treatment, by printing, or by coating, after the flexible support has been made.

Preferably, the active substance is applied to the surface of the corresponding flexible support.

The active substance may be incorporated or applied in the form of particles in or on the flexible support or in the adhesive, and may for example change state under the action of an external stimulus, such as heat, for example. The active substance may also be incorporated or applied in liquid form in or on the flexible support.

The active substance may be incorporated or applied in encapsulated form in or on the flexible support or in the adhesive, and it be released under the action of an external stimulus, such as heat or pressure, for example.

The active substance may be applied to the entire area of one of the flexible supports. In a variant, the active substance may be deposited on discrete zones of at least one of the two supports, e.g. in a region that is to receive the antenna.

Preferably, the active substance is applied to or incorporated in a flexible support that does not include compounds that might prematurely trigger a reaction process with the active substance, even in the event of prolonged storage of the support prior to assembly. Otherwise, provision can be made for the active substance to be provided in sufficient quantity so as to ensure it is still capable of triggering a reaction process with the adhesive that comes to face it when the two supports are assembled together.

The active substance may be incorporated in one of the adhesives during fabrication of the adhesive, or else at the last moment during working of the adhesive, in particular while the adhesive is being deposited on the corresponding support.

The adhesive(s) concerned by the invention may be polymers in an emulsion in water, in solution in solvents, or constituting 100% of the active material (e.g. a hot-melt adhesive in the liquid state, or a resin).

Prior to assembly, the adhesive(s) may be in the form of a fluid or a transfer adhesive film.

The flexible supports may be of fiber or non-fiber materials, possibly including natural or synthetic materials such as prepolymers, polymers, or combinations thereof. It is possible to use flexible supports in woven or non-woven or knitted form, in the form of an extruded or injected thermoplastic film, or in sheet form.

Prior to the supports being assembled together, the antenna may be secured to one of the supports in various ways, e.g. by thermocompression, by an ultrasound method, or by an adhesive, e.g. using an adhesive present on the support.

In implementations of the invention, at least one of the two supports is made at least in part out of fibers. Each of the two supports may comprise cellulose and synthetic fibers, for example.

The RFID device may include an antenna that can be connected at its ends to a chip or a module. In particular, the RFID device may include at least one micro integrated chip. In a variant, the antenna is not electrically connected to the chip or the module, but is electromagnetically coupled to the chip or to the module, which chip or module then has its own antenna integrated therein.

The antenna may be put into place and held on the first support, e.g. by an ultrasound or a thermocompression method, with one of the supports carrying the active substance, e.g. in its mass or on its surface, and the other support receiving the adhesive that is to react, in particular cross-link, in the presence of the active substance, which active substance is put into contact with the adhesive when the supports are assembled together. The support carrying the active substance may be the second support. The active substance may be released by applying heat. If heat is applied, the adhesive also includes a second active substance, in particular a catalyst suitable for triggering or accelerating the process of the adhesive being cross-linked by the first active substance.

In a variant, the method may comprise the steps consisting in:
depositing a first adhesive on the first support, at least in a region that is to receive the antenna;
placing the antenna at least on said first adhesive, the first adhesive presenting sufficient tackiness to ensure that the antenna wire put into contact therewith remains on the first support;
depositing a second adhesive on the second support, the second adhesive including the active substance, which active substance is capable of causing both the first adhesive and the second adhesive to cross-link, e.g. optionally under the action of heat; and
assembling together the first and second supports, in particular while hot.

The first and second adhesives may comprise polymers of the same kind.

In another variant, the method may comprise the steps consisting in:
depositing a first adhesive on the first support, at least in a region that is to receive the antenna, the first adhesive comprising an adhesive mass A₁ and an active substance S₁, in particular a hardener;
depositing a second adhesive on the second support, in particular over its entire area, the second adhesive comprising an adhesive mass A₂ and an active substance S₂, in particular a hot-activatable cross-linking agent;
putting the adhesive masses A₁ and A₂ into contact and subjecting them to a stimulus, e.g. applying heat, the active substances S₁ and S₂ serving, in the presence of the stimulus, in particular heat, to cross-link the adhesive masses A₁ and A₂.

In another variant, the method may comprise the steps consisting in:
depositing a coating, in particular a varnish, on the first support, the coating including the active substance, in particular a hardener;
depositing the adhesive on the second support, said adhesive being capable of polymerizing in contact with the active substance; and
assembling the two supports together, in particular under pressure, in order to put the active substance into contact with the adhesive.

In another variant, the method may comprise the steps consisting in:
fabricating the first and second supports, each with an active substance, in particular a cationic cross-linking agent;
placing the antenna on the first support, in particular by a thermocompression or ultrasound method; and
depositing a hot-melt adhesive on the second support, the active substances of the first and second supports being capable of causing the adhesive to cross-link after exposure to a stimulus, in particular a source of radiation, in particular UV or EB radiation.

In another variant, the method may comprise the steps consisting in:
depositing, on the first support, a first adhesive mass A₁ having an active substance S₂ added thereto, in particular depositing it over the entire area of the first support; and
depositing, on the second support, a second adhesive mass A₂ having an active substance S₁ added thereto;

the active substance S₁ being selected to react with the adhesive mass A₁, and the active substance S₂ being selected to react with the adhesive mass A₂ while the supports are assembled together.

In another variant, the method may comprise the steps consisting in
depositing a first adhesive on the first support, at least in a region that is to receive the antenna, the first adhesive comprising an adhesive mass A₁ and an active substance S₂ capable of cross-linking at least the adhesive mass A₂ at a temperature T₂;
depositing a second adhesive on the second support, the second adhesive comprising an adhesive mass A₂ and an active substance S₁ capable of cross-linking at least the adhesive mass A₁ at a temperature T₁; and
putting the adhesive masses A₁ and A₂ into contact and heating them, in particular holding the assembly at the temperatures T₁ and T₂ so as to cause the active substances S₁ and S₂ to cross-link the adhesive masses A₁ and A₂.

The insert may be fastened to another element via a face of one of the supports or it may be fastened to two elements via the opposite faces of the supports.

One of the supports may include an active substance capable of causing or accelerating a reaction process with an adhesive carried by an element brought into contact therewith.

The invention also provides an insert as fabricated by the above method.

This insert includes a first flexible support optionally provided with a recess, a second flexible support optionally provided with a recess, and an RFID device including an antenna, the device being located at least in part between the two supports.

The two supports and the RFID device are assembled together in irreversible manner via one or more adhesives in such a manner that the antenna and the chip or the module optionally connected to said antenna are to be found between the two supports, the chip or the module being optionally housed in superposed recesses of the two supports. At least one of the two supports carries at least one active substance capable of causing or accelerating a reaction process with at least one adhesive carried by the other support.

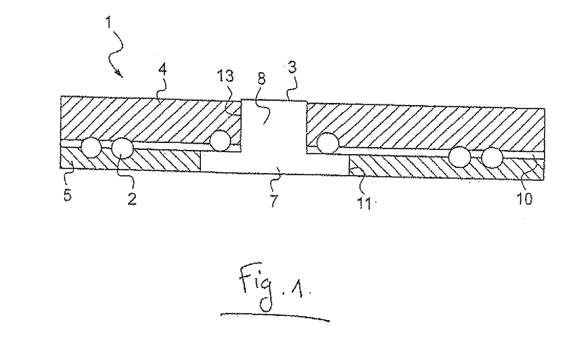

The invention can be better understood on examining the accompanying drawing in which FIG. 1 is a diagrammatic section view of an example of an insert 1 made in accordance with the invention.

This insert 1 comprises a first support 5, an electronic RFID component, specifically a module 3, a second support 4, and a wire antenna 2, e.g. made of copper with a skin provided with a heat-sealable varnish. The supports 4 and 5 may optionally have the same dimensions. The supports 4 and 5 may be of optionally-coated paper using synthetic and/or natural fibers.

The module 3 in the example described comprises a base 7, also referred to as a lead frame, and a projection 8 housing an RFID chip, where such a projection is also referred to as potting.

The antenna 2 is electrically connected at its ends to respective contacts situated on the base 7, e.g. on either side of the projection 8.

The first and second supports 5 and 4 are connected together by a joint 10 comprising one or more adhesives.

The first support 5 may include a recess 11 receiving the base 7, and the second support 4 may include a recess 13 receiving the projection 8. The recesses 11 and 13 may be windows of different dimensions, as shown.

In variants that are not shown, at least one of the supports does not include a recess, or indeed neither of the supports includes a recess. Where appropriate, the insert may also include a third support that is flexible, e.g. fastened to the second support in order to mask the chip or the module. The recesses may optionally be through holes. Such an insert may be designed to be inserted in a security document such as a passport or an identity card, for example.

In a first embodiment of the invention, two supports and the RFID device are assembled together in irreversible manner using a single adhesive. By way of example, the antenna of the RFID device is initially put into place, in particular unwound and embedded on one of the faces of the first support 5, e.g. by an ultrasound or a thermocompression method, and is then connected via its two ends to the module.

An adhesive is coated onto all of the surface of the second support 4, with this adhesive presenting, after coating, the property of being activatable by means of a stimulus such as temperature, for example.

In order to produce an assembly that is irreversible, i.e. that is tamperproof, once the two supports have been hot-rolled under pressure, the first support on which the antenna is deposited may be made in such a manner as to include in its basic formulation an active substance and more particularly a cross-linking agent, said cross-linking agent having the subsequent function of causing the adhesive coated on the second support to cross-link on being brought face to face therewith during assembly,

The cross-linking of the adhesive by the first active substance may take place an ambient temperature, or it may be triggered or enhanced (shortening cross-linking time) by applying heat immediately before or during assembly of the two supports, and/or by the presence of a second active substance, such as a catalyst, e.g. in the adhesive. Incorporating an active substance such as a cross-linking agent in the first support and not directly in the adhesive presents the advantage of preventing premature cross-linking of the adhesive before the two supports are assembled together.

### EXAMPLE 1

A temperature-activatable adhesive is deposited on the second support 4, this adhesive comprising an adhesive mass based on polyol and a first active substance, which active substance may for example be a catalyst of amine nature or an amine derivative.

The first support 5 on which the antenna 2 is fastened includes a second active substance, e.g. a cross-linking agent, e.g. particles of deactivated diisocyanate.

While the two supports 4 and 5 are being assembled together at a temperature that is high enough to activate the release of diisocyanate, cross-linking of the polyol is triggered, and said cross-linking is catalyzed by the presence of an amine.

In a second implementation of the invention, the two supports and the RFID device are assembled together in irreversible manner by means of two adhesives.

The first adhesive is deposited locally on the first support 5, at least in the zone in which the antenna extends. This adhesive has the property of presenting sufficient tackiness to enable the antenna wire to be unwound in contact therewith and to remain in place until assembly with the second support.

The second adhesive is deposited, e.g. coated, on the second support 4, preferably over its entire area, with this adhesive, for example, not being tacky when cold after coating, and presenting the property of being reactivatable at a higher temperature. The composition of this adhesive may present a polymer-based adhesive mass together with an active substance. By way of example the active substance is a latent cross-linking agent, with this cross-linking agent having the function of cross-linking both the adhesive mass in which it is mixed under the action of heat during assembly, and also the adhesive mass of the adhesive carried by the first support and present in the antenna zone, with which it comes face to face during assembly.

In order to implement this example, it is possible to use a cross-linking agent that is capable of causing the adhesive mass in which it is mixed to cross-link and that is also capable of causing the adhesive mass with which it comes face to face to cross-link. For this purpose, it is preferable to use two adhesives that include adhesive masses with polymers that are in part of the same kind.

If the active substance of the adhesive of the second support is not capable of cross-linking the adhesive present in the antenna zone of the first support, it is found that the assembly is not tamperproof, i.e. when making an attempt at falsification by peeling the assembly apart dry, it is found that it is possible to separate the two supports from each other without destroying the supports in the zone where the two adhesives face each other, thus making it possible to recover RFID device without damage.

### EXAMPLE 2

A first adhesive is applied locally on the first support 5 and comprises an adhesive mass in the form of a polyurethane resin in dispersion presenting a certain amount of tackiness at ambient temperature in order to hold the antenna 2. Optionally, a resin for increasing tackiness may be added to the polyurethane resin, where appropriate.

A second adhesive comprising an adhesive mass based on single-component reactive polyurethane that hardness at a threshold temperature by virtue of a latent cross-linking agent, e.g. particles of surface-deactivated isocyanate is coated on the second support 4 and then dried at 30° C., a temperature lower than the hardening temperature of the adhesive mass.

When hot-rolling the two supports at a temperature that corresponds to the temperature for releasing isocyanate and that is also higher than the crystallization temperature of polyurethane, so that the antenna wire is sandwiched, the isocyanate hardener for the hot-activatable adhesive cross-links the mass of polyurethane with which it is mixed and also cross-links the mass of adhesive of the same kind in the facing adhesive that is holding the antenna, thereby creating an irreversible assembly both in the antenna zone, and away from the antenna.

In a third embodiment of the invention, both supports are assembled together in irreversible manner by means of two adhesives. The first adhesive is deposited locally on the first support 5 at least in the zone where the antenna 2 extends. This adhesive comprises a polymer-based adhesive mass A₁ and an active substance S₁, and more particularly a hardener. A second adhesive is coated, e.g. onto the entire area of the support 4, this adhesive presenting a small amount of tackiness when cold after coating, and presenting the property of being activatable at a higher temperature. This adhesive comprises a polymer-based adhesive base A₂ together with an active substance S₂, and more particularly a cross-linking agent that responds to heat. When the two supports are assembled together hot so that the antenna is sandwiched, the active substance S₁ cross-links the active mass A₁ and also the facing adhesive mass A₂, and the active substance S₂ cross-links the adhesive mass A₂ and also the facing adhesive mass A₁.

Similarly, we can achieve another embodiment in which the first adhesive includes an adhesive mass based on acrylic and the second adhesive also includes an adhesive mass based on acrylic and curing at a threshold temperature thanks to a latent crosslink, a blocked isocyanate for example.

### EXAMPLE 3

The first adhesive holding the antenna 2 on the first support 5 comprises a urethane acrylate prepolymer in a solvent medium together with a cross-linking agent of the isocyanate type in a solvent medium. This hardener is suitable for cross-linking the prepolymer under the influence of ambient humidity, thus enabling the antenna 2 to be held in place before assembly with the second support 4.

The hot-activatable second adhesive coated on the second support 4 comprises an acrylate copolymer together with a melamine type cross-linking agent. Cross-linking of the second adhesive takes place as from 140° C.

When hot-laminating the two supports together so that the antenna wire 2 is sandwiched between them, the melamine resin of the hot-activatable adhesive cross-links the acrylic polymer with which it is mixed, and also cross-links the facing urethane acrylic adhesive, and the isocyanate hardener of the adhesive that holds the antenna and that initially cross-links the urethane acrylate prepolymer with which it is mixed then cross-links the facing acrylic adhesive, thereby creating a tamperproof assembly both in the antenna zone and away therefrom.

In a fourth implementation of the invention, at least one of the two supports, and possibly both of them, is initially surfaced with a varnish including an active substance, and more particularly a hardener. The first support is stored up to the time when the antenna is inserted, e.g. by using an ultrasound or a thermocompression method, and then to the moment of assembly with the second support.

During assembly, an adhesive mass is coated on the second support and the first support is then immediately pressed against the second support with pressure being applied at ambient temperature. During cold assembly and the application of pressure, the adhesive comes into contact with the hardener and polymerization begins.

### EXAMPLE 4

The adhesive on the second support 4 comprises a methacrylate polymer and the hardener varnish on the first support 5 preferably includes a functional group selected from one of the following groups: amine, anhydric, diacid, polyamide, and diisocyanate.

During cold assembly and while pressure is applied, the adhesive is once more in contact with the hardener and polymerization begins. This method does not require any previous mixing of the hardener and the adhesive and therefore limits problems associated with measured quantities, with proportions in the mixture, and with handling times. The resulting insert presents high levels of physical and mechanical strength, and of chemical resistance.

In a fifth implementation of the invention, both supports are assembled together in irreversible manner by means of a single adhesive. The antenna of the RFID device is for example fastened using an ultrasound or a thermocompression method on one face of the first support, and is connected via its two ends to a chip.

A hot-melt adhesive is deposited by an appropriate deposition system onto the entire area of the second support. This support is then assembled with the first support so as to sandwich the antenna between them.

Hot-melt adhesives present the advantage of setting quickly, but they are poor at withstanding heat and solvents. In order to create an assembly that is tamperproof after the two supports have been assembled together and subjected to pressure, the two flexible supports are fabricated in such a manner as to include an active substance at least on their surfaces that face the hot-melt adhesive, and more particularly the active substance is a cationic cross-linking agent.

Cross-linking of the adhesive mass by means of a cationic cross-linking agent present in both supports does not occur as soon as the two supports come into contact during assembly, but begins on exposure to UV irradiation.

Even if the flexible supports are not transparent, cross-linking initiated at the edge of the adhesive joint by means of UV irradiation can then propagate to the inside of the joint.

### EXAMPLE 5

The first support 5 includes a first active substance, e.g. a cationic cross-linking agent. The second support 4 includes a second active substance, e.g. a cationic cross-linking agent. The antenna 2 is fastened by an ultrasound method to the first flexible support 5. An epoxy-based hot-melt adhesive mass is applied when hot onto the flexible support 4 which is then immediately rolled against the first flexible support 5. Cross-linking of the epoxy chains and bridging then begin when the supports are put into contact and the assembly is subjected to UV irradiation, solely via the edge if the supports are not transparent.

In a sixth implementation of the invention, the two supports and the RFID device are assembled together in irreversible manner by means of two adhesives.

A first adhesive mass A₁ having an active substance S₂ added thereto is deposited, in particular coated, on the first support 5, and in particular over its entire area. After coating, this adhesive mass presents the property of presenting no tackiness at ambient temperature immediately after being put into place and of being capable of entering into a reaction process in the presence of another active substance S₁, at a temperature T₁.

A second active mass A₂, having an active substance S₁ added thereto, is deposited, in particular coated, over the entire area of the second support 4. After coating this adhesive mass also presents the property of being without tackiness at ambient temperature immediately after being put into place and of being capable of entering into a reaction process in the presence of another active substance S₂, at a temperature T₂, where the temperature T₁ may be equal to the temperature T₂.

The antenna 2 of the RFID device is unwound and fastened, e.g. by a thermocompression or an ultrasound method at the softening temperature of the adhesive mass A₁ coated on the first support 5 and is then connected via its two ends to the chip.

In order to create an assembly that is irreversible, i.e. tamperproof after the two supports have been hot-rolled together under pressure, the active substance S₂ is selected to react with the adhesive mass A₂ of the second support 4, while the active substance S₁ is selected to react with the adhesive mass A₁ of the first support 5.

The two reaction processes take place simultaneously or successively with the temperatures T₁ and T₂ being held for a while during the cycle of assembling together the two supports while hot, thereby creating a three-dimensional lattice in the joint. The admixture in the coatings on the supports of an active substance together with the adhesive mass with which there is no reaction process presents the advantage of avoiding premature cross-linking of the adhesive mass coated on either of the two supports, prior to the supports being assembled together.

In general, and in particular in the above examples, both supports may present on their outer surfaces, i.e. their surfaces that are not in contact with the antenna, in intrinsic or in other manner, an active substance that is capable of causing or accelerating a reaction process with an adhesive, e.g. a vinyl or an acrylic adhesive, used for assembling the insert with some other flexible support, or respectively with the flyleaf and the cover of a passport.

This active substance may be activated, where necessary, by applying heat, by UV, EB radiation, etc.

The invention is not restricted to the above-described examples. Particular implementation features in these examples can be combined within variants that are not shown.

The term “comprising a” should be understood as being synonymous with “comprising at least one”, unless specified to the contrary.

1-34. (canceled)

35. A method of fabricating an insert comprising at least a first flexible support, a second flexible support assembled with the first, and an RFID device that is situated at least in part between the two supports, the method comprising:
depositing at least one adhesive on a face of at least one of the supports, the other support carrying at least one active substance; and
assembling the two supports together, the active substance being capable of causing or accelerating a reaction process with the adhesive.

36. A method according to claim 35, the active substance being capable of causing or accelerating the reaction process as soon as it is put into contact with the adhesive.

37. A method according to claim 35, the active substance requiring an external stimulus in order to trigger or accelerate the reaction process.

38. A method according to claim 37, the external stimulus being a temperature rise.

39. A method according to claim 37, the external stimulus being exposure to UV or EB radiation.

40. A method according to claim 35, the RFID device including at least one chip.

41. A method according to claim 35, the RFID device including an antenna.

42. A method according to claim 41, the antenna being placed and held on the first support, one of the supports carrying an active substance, the other support receiving the adhesive, which adhesive is capable of reacting, in particular of cross-linking, in the presence of the active substance, the active substance being put into contact with the adhesive when the supports are assembled together.

43. A method according to claim 42, the antenna being placed and held on the first support by a thermocompression method or an ultrasound method.

44. A method according to claim 42, the active substance being released by applying heat.

45. A method according to claim 42, the support carrying the active substance being the first support.

46. A method according to claim 42, the first support including a first active substance, the adhesive deposited on the second support including a second active substance.

47. A method according to claim 42, the adhesive comprising a polyol based adhesive mass and an active substance such as a catalyst of amine or amine derivative kind, and the first support carrying another active substance such as a cross-linking agent in the form of deactivated diisocyanate particles.

48. A method according to claim 35, comprising:
depositing a first adhesive on the first support, at least in a region that is to receive the antenna;
placing the antenna at least on said first adhesive, the first adhesive presenting sufficient tackiness to ensure that the antenna wire put into contact therewith remains on the first support;
depositing a second adhesive on the second support, the second adhesive including the active substance, which active substance is capable of causing both the first adhesive and the second adhesive to cross-link; and
assembling together the first and second supports.

49. A method according to claim 46, the first and second adhesives comprising polymers of the same kind.

50. A method according to claim 47, the first and second adhesives being based on polyurethane or acrylic.

51. A method according to claim 49, the active substance being a latent cross-linking agent based on surface-deactivated particles of isocyanate.

52. A method according to claim 35, comprising:
depositing a first adhesive on the first support, at least in a region that is to receive the antenna, the first adhesive comprising an adhesive mass A₁ and an active substance S₁;
depositing a second adhesive on the second support, the second adhesive comprising an adhesive mass A₂ and an active substance S; and
putting the adhesive masses A₁ and A₂ into contact, the active substances S₁ and S₂ cross-linking the adhesive masses A₁ and A₂ in the presence of heat.

53. A method according to claim 52, the first adhesive comprising a urethane acrylate prepolymer in a solvent medium and a cross-linking agent, in a solvent medium.

54. A method according to claim 52, the second adhesive comprising an acrylate copolymer and a cross-linking agent.

55. A method according to claim 35, comprising:
depositing a coating, on the first support, the coating including the active substance;
depositing the adhesive on the second support, said adhesive being capable of polymerizing in contact with the active substance; and
assembling the two supports together in order to put the active substance into contact with the adhesive.

56. A method according to claim 55, the adhesive including a methacrylate polymer and the hardener including a functional group selected from one of the following groups: amine, anhydric, diacid, polyamide, and diisocyanate.

57. A method according to claim 35, comprising:
fabricating the first and second supports, each with an active substance;
placing the antenna on the first support; and
depositing a hot-melt adhesive on the second support, the active substances of the first and second supports being capable of causing the adhesive to cross-link after exposure to a stimulus.

58. A method according to claim 57, the hot-melt adhesive comprising an epoxy-based adhesive mass.

59. A method according to claim 35, comprising:
depositing, on the first support, a first adhesive mass A₁ having an active substance S₂ added thereto; and
depositing, on the second support, a second adhesive mass A₂ having an active substance S₁ added thereto;
the active substance S₁ being selected to react with the adhesive mass A₁, and
the active substance S₂ being selected to react with the adhesive mass A₂ while the supports are assembled together.

60. A method according to claim 35, comprising:
depositing a first adhesive on the first support, at least in a region that is to receive the antenna, the first adhesive comprising an adhesive mass A₁ and an active substance S₂ capable of cross-linking at least the adhesive mass A₂ at a temperature T₂;
depositing a second adhesive on the second support, the second adhesive comprising an adhesive mass A₂ and an active substance S₁ capable of cross-linking at least the adhesive mass A₁ at a temperature T₁; and
putting the adhesive masses A₁ and A₂ into contact and heating them, by holding the assembly at the respective temperatures T₁ and T₂ so as to cause the active substances S₁ and S₂ to cross-link the adhesive masses A₁ and A₂.

61. A method according to claim 35, the insert being fastened to another element via one face of one of the supports or being fastened to two elements by the opposite faces of the two supports.

62. A method according to claim 61, one of the supports carrying an active substance capable of causing or accelerating a reaction process with an adhesive or glue used for fastening the element brought into contact therewith.

63. A method according to claim 61, the two elements being respectively a cover and a flyleaf of a passport booklet.

64. A method according to claim 61, the two elements being respectively plastic films of an ID card.

65. A method according to claim 35, the active substance being a catalyst.

66. A method according to claim 35, the active substance being a polymerization activator or initiator.

67. A method according to claim 35, the active substance being a hardener or a cross-linking agent.

68. An insert obtained by implementing the method defined in any claim 35.

69. A security document including an insert as defined in claim 68.
